(19) United States
(12) Patent Application Publication
(10) Pub. No.: US 2023/0120242 A1
(43) Pub. Date: Apr. 20, 2023

(54) APPARATUS, SYSTEMS, AND METHODS FOR SOCIAL MEDIA STREAMING DEVICES

(71) Applicant: Meta Platforms, Inc., Menlo Park, CA (US)

(72) Inventor: Colleen Kelly Henry, Oakland, CA (US)

(21) Appl. No.: 17/504,285

(22) Filed: Oct. 18, 2021

(51) Int. Cl. H04N 5/77; H04N 7/10; H04N 5/225; H04N 5/907; H04L 29/06

(52) U.S. Cl. CPC H04N 5/77; H04N 7/10; H04N 5/2257; H04N 5/2251; H04N 5/907; H04L 65/1059

(57) ABSTRACT

An apparatus for a social media streaming device may include (i) a camera connector that connects to and receives streaming video data from an external camera, (ii) a device connector that connects to and sends the streaming video data to a mobile device with network streaming capabilities, and (iii) a video processing module that enables the social media streaming device to, via the mobile device with network streaming capabilities, post the streaming video data to an account on a social media platform on behalf of a user. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an exemplary system for streaming social media via a social media streaming device.

FIG. 2 is a block diagram of an exemplary system for streaming social media via a social media streaming device.

FIG. 3 is a flow diagram of an exemplary method for streaming social media via a social media streaming device.

FIG. 4 is an illustration of a rear view of a social media streaming device.

FIG. 5 is an illustration of a front view of a social media streaming device.

FIG. 6 is an illustration of a side view of a social media streaming device.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The instant disclosure is generally directed to apparatuses, systems, and methods for enabling consumer-grade smartphones to integrate with professional-grade video production equipment for the purposes of streaming live events to social media. In one example, a social media streaming device may enable a smartphone to access a feed from an external camera and stream that feed via an account on a social media platform to which the smartphone is authenticated. In some embodiments, the systems described herein may stream the camera feed using settings configured on the social media account. In one embodiment, a social media streaming device may be designed to physically attached to a smartphone (e.g., as a phone “backpack”). To facilitate streaming long events (e.g., events lasting several hours), in some embodiments, the social media streaming device may include one or more long-lasting batteries that may power the social media streaming device and/or the connected smartphone. In some examples, the camera integration, network connectivity, and/or additional battery charge provided by a social media streaming device may enable a user being filmed professionally at an event to livestream the event via their social media account with a minimum of set-up.

In some embodiments, the systems described herein may improve the functioning of a computing device by enabling a consumer-grade computing device to interface with a professional camera and/or stream video captured by a professional camera. Additionally, the systems described herein may improve the fields of video streaming and/or social media by enabling users to stream professionally captured video to their social media platforms from their phones.

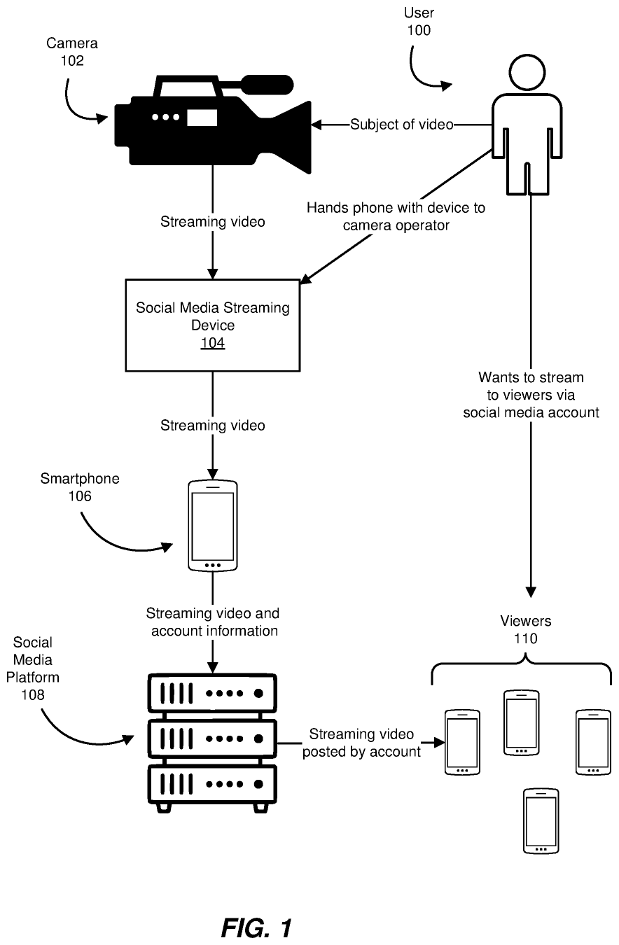

In some embodiments, the systems described herein may enable the subject of a video to stream the video to their followers on social media via their phone with a minimum of inconvenience. For example, as illustrated in FIG. 1, a user 100 may be the subject of a video being shot by a camera 102. For example, user 100 may be a participant in competitive alligator wrestling, which camera 102 may be capturing for a live broadcast on a television channel dedicated to sporting events. In one example, user 100 may have secured an agreement with the operator of camera 102 to also stream the alligator-wrestling competition on social media and user 100 may hand a smartphone 106 equipped with a social media streaming device 104 to the operator of camera 102. In some embodiments, social media streaming device 104 may be equipped with connectors capable of interfacing with camera 102 to receive streaming video as well as connectors capable of interfacing with smartphone 106 to send streaming video. In one example, smartphone 106 may send the streaming video received via social media streaming device 104 to a social media platform 108 that hosts the video for access by viewers 110, enabling social media followers of user 100 watch the alligator-wrestling competition live and in professional quality on the social media page of user 100.

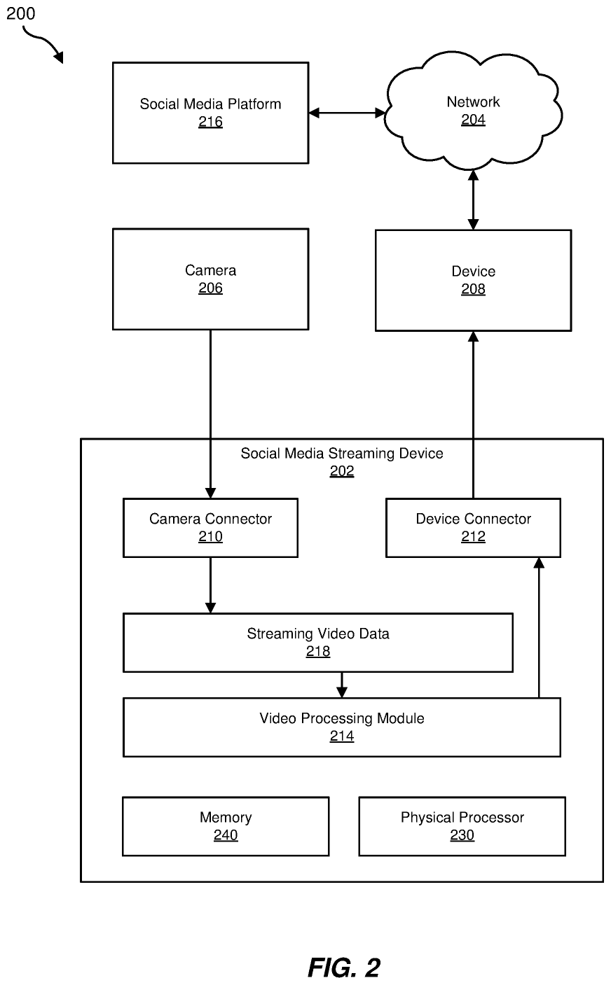

In some embodiments, the systems described herein may facilitate social media streaming from an external device (e.g., a mobile device) to a network. FIG. 2 is a block diagram of an exemplary system 200 for facilitating social media streaming. In one embodiment, and as will be described in greater detail below, a social media streaming device 202 may be configured with a camera connector 210 that connects to and receives streaming video data 218 from a camera 206, a device connector 212 that connects to and sends streaming video data 218 to a device 208, and a video processing module 214 that enables social media streaming device 202 to, via device 208, post streaming video data 218 to an account on a social media platform 216 on behalf of a user (e.g., via a network 204).

Social media streaming device 202 generally represents any type or form of purpose-built device designed to facilitate video streaming from an external camera via a mobile device. In some embodiments, social media streaming device 202 may be designed to be physically affixed to a mobile device and/or to a camera.

Camera 206 generally represents any type or form of device primarily designed to capture video. In some embodiments, camera 206 may be a professional-grade video camera capable of capturing high-definition video and/or video at a level of quality exceeding that of consumer-grade cameras (e.g., cameras in mobile phones). In some embodiments, camera 206 may send video data to other devices via a specialized connector, such as a high definition serial digital interface connector (HD-SDI) connector, rather than a more common type of connector such as a universal serial bus (USB) connector or a high-definition multimedia interface (HDMI) connector.

Device 208 generally represents any type or form of mobile computing device capable of reading computer-executable instructions and connecting to a network. For example, device 208 may represent a smartphone. Additional examples of device 208 may include, without limitation, a wearable device, a smart device, an artificial reality device, a personal digital assistant (PDA), etc.

Network 204 generally represents any type or form of network capable of transmitting digital signals. In some embodiments, network 204 may represent a wireless network, such as a wi-fi or cellular network. Additionally or alternatively, network 204 may represent a wired network, such as a wired local area network (LAN). Although illustrated as a single element, network 204 may represent multiple connected networks, such as one or more LANs connected to the Internet.

Camera connector 210 generally represents any type or form of physical connection between a camera and a device. In one embodiment, camera connector 210 may include a port and/or a cable that connects to a port. In some embodiments, camera connector 210 may include a specific type of port or cable, such as HD-SDI, HDMI, and/or USB. In some embodiments, social media streaming device 202 may be equipped with multiple different types of camera connectors. For example, social media streaming device 202 may be equipped with an HD-SDI port and/or cable for connecting to professional-grade video production equipment as well as an HDMI port and/or cable for connecting to consumer-grade cameras. In one embodiment, social media streaming device 202 may be equipped to receive and/or send wireless zero-latency video production signals, such as wireless home digital interface (WHDI) signals. In some embodiments, camera connector 210 may include separate video and audio connectors. For example, camera connector 210 may include a connector for receiving balanced or unbalanced analog audio signals, such as an XLR connector.

Device connector 212 generally represents any type or form of physical connection between two devices. In one embodiment, device connector 212 may include a port and/or a cable that connects to a port. In some embodiments, device connector 212 may include a locking connector (e.g., a port-cable connection that locks securely into place such that it is less likely to be accidentally dislodged). For example, device connector 212 may include a Lightning connector.

Streaming video data 218 generally represents any type or form of digital video that is transmitted as it is recorded. In some embodiments, streaming video data 218 may be captured in an uncompressed and/or unencoded form by camera 206 before being processed by social media streaming device 202. In some examples, streaming video data 218 may be video data of a live event, such as an interview, press conference, sporting event, theatrical event, political event, and/or any other relevant type of event.

Social media platform 216 generally refers to any type or form of digital architecture (e.g., provided by one or more servers) that enables digital social networking. In one embodiment, social media platform 216 may enable users to post various types of media to their user accounts and/or user pages on the social media platform, such as streaming video. In some embodiments, social media platform 216 may enable users to follow a user account in order to be alerted when that user account posts something and/or view posts by that user account.

As illustrated in FIG. 2, example system 200 may also include one or more memory devices, such as memory 240. Memory 240 generally represents any type or form of volatile or non-volatile storage device or medium capable of storing data and/or computer-readable instructions. In one example, memory 240 may store, load, and/or maintain one or more of the modules illustrated in FIG. 2. Examples of memory 240 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 2, example system 200 may also include one or more physical processors, such as physical processor 230. Physical processor 230 generally represents any type or form of hardware-implemented processing unit capable of interpreting and/or executing computer-readable instructions. In one example, physical processor 230 may access and/or modify one or more of the modules stored in memory 240. Additionally or alternatively, physical processor 230 may execute one or more of the modules. Examples of physical processor 230 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

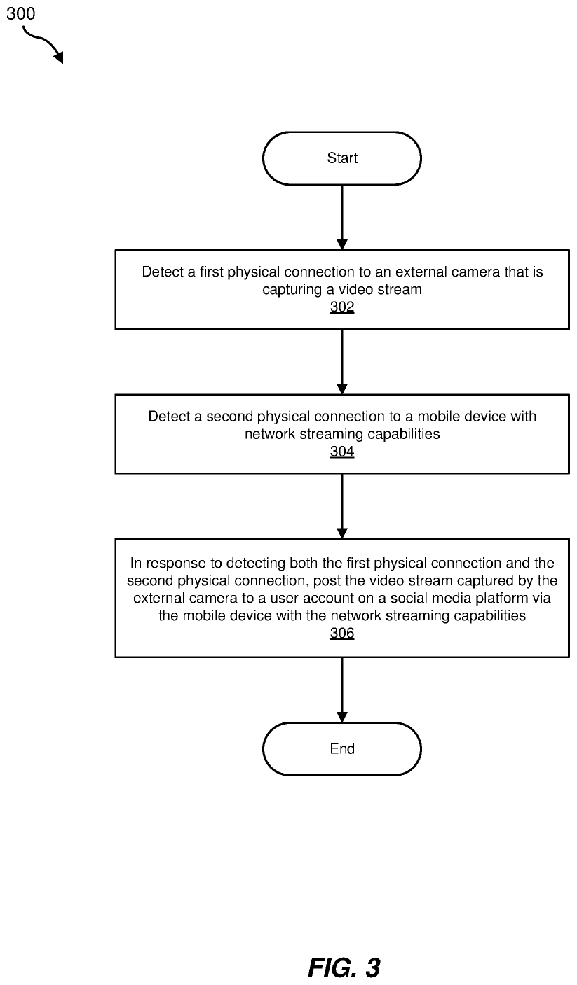

FIG. 3 is a flow diagram of an exemplary method 300 for streaming video to social media platforms. In some examples, at step 302, the systems described herein may detect a first physical connection to an external camera that is capturing a video stream.

The systems described herein may detect the physical connection to the camera in a variety of ways. In one example, the systems described herein may detect a physical connection to a device, identify the device as the external camera, and receive the video stream from the external camera. For example, the systems described herein may detect the physical connection to the camera by detecting that a cable is connected to an HD-SDI and/or HDMI port on the social media streaming device and/or that a device is sending streaming video data to the social media streaming device via a HD-SDI, HDMI, and/or other relevant type of connection.

At step 304, the systems described herein may detect a second physical connection to a mobile device with network streaming capabilities. The systems described herein may detect the physical connection to the mobile device in a variety of ways. For example, the systems described herein may detect a physical connection to a device and identify the device as a type of device with network streaming capabilities. In one embodiment, the systems described herein my detect that a cable is connected to a specified port (e.g., a USB port, a Lightning port, etc.) for mobile device connections. In some embodiments, the systems described herein may send data to and/or receive data from a streaming app on the mobile device configured to work with the social media streaming device. Additionally or alternatively, the systems described herein may send data to and/or receive data from a social networking app on the mobile device.

At step 306, the systems described herein may, in response to detecting both the first physical connection and the second physical connection, post the video stream captured by the external camera to a user account on a social media platform via the mobile device with the network streaming capabilities.

The systems described herein may post the video stream in a variety of ways. For example, the systems described herein may transmit the video stream to a social media app on the mobile device that posts the stream. In one embodiment, the social media streaming device may be configured with one or more modems (e.g., a cellular modem and/or a wi-fi modem) that assist the mobile device in posting the stream by providing a network connection for the mobile device. In some embodiments, the systems described herein may automatically post the video stream in response to detecting the connections to the mobile device and camera. Additionally or alternatively, the systems described herein may post the stream in response to receiving user input initiating the posting of the stream. For example, a user may initiate posting of the stream via social media app on the mobile device, via a hardware button on the social media streaming device, and/or via any other suitable type of user interface.

In one embodiment, the systems described herein may receive the video stream from the external camera, process the video stream, and transmit the processed video stream to the mobile device. For example, the systems described herein may compress the video stream, encode the video stream (e.g., via a video codec), reformat the video stream, and/or perform any other relevant processing on the video stream before sending the video stream to the mobile device.

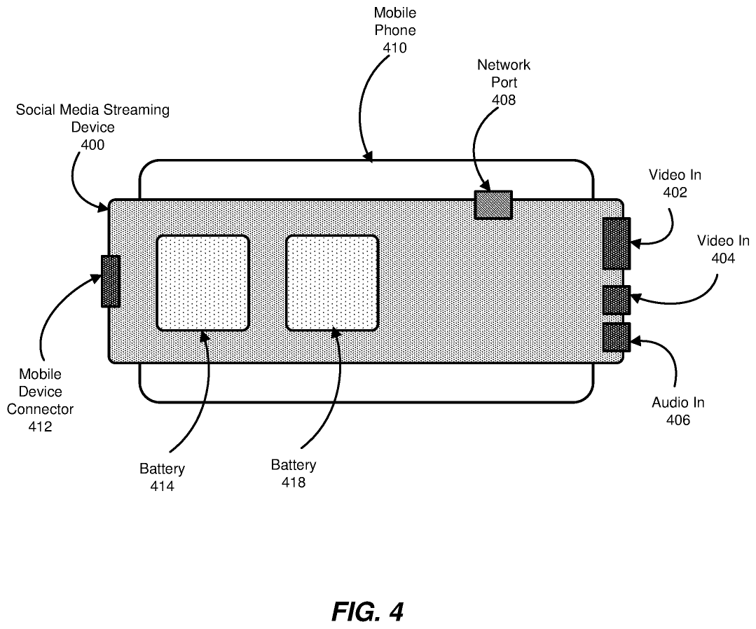

In some embodiments, the social media streaming device may be physically configured to attach to the back of a mobile phone. For example, as illustrated in FIG. 4, a social media streaming device 400 may attach to the back of a mobile phone 410 such that various ports and/or other features of social media streaming device 400 are accessible. In one embodiment, social media streaming device 400 may include a video in 402, such as an HD-SDI port, as well as a video in 404, such as a HDMI port. By include both types of ports, social media streaming device 400 may be configured to be connected to either a professional-grade camera or a consumer-grade camera. In one embodiment, social media streaming device 400 may include an audio in 406 that may enable social media streaming device 400 to receive input via an audio cable. In some embodiments, social media streaming device 400 may have a mobile device connector 412 that enables social media streaming device 400 to have a wired connection to mobile phone 410. In some embodiments, mobile device connector 412 may enable social media streaming device 400 to send data and/or electrical charge to mobile phone 410.

In one embodiment, social media streaming device 400 may be configured with a battery 414 and a battery 418 that provide power not just to social media streaming device 400 but also to mobile phone 410, extending the battery life of mobile phone 410 while performing power-intensive operations such as streaming video. In one embodiment, social media streaming device 400 may be configured such that battery 414 is capable of providing power to social media streaming device 400 and/or mobile phone 410 while battery 418 is being replaced (e.g., with a fresh, fully charged battery) and/or vice versa, enabling uninterrupted streaming during battery replacement.

In some embodiments, social media streaming device 400 may have a network port 408 (e.g., an ethernet port) that enables social media streaming device 400 to provide a connection to a wired network to mobile phone 410. By connecting mobile phone 410 to a wired network, social media streaming device 400 may improve the quality and/or efficiency of posting the streaming video to the social media platform compared to posting the streaming video via a wireless network. For example, mobile phone 410 may be able to transmit larger file sizes and/or transmit files more quickly via a wired network compared to a wireless network. In some embodiments, social media streaming device 400 may have multiple network ports. For example, social media streaming device 400 may include an ethernet port for transmitting standard data and an ethernet port for transmitting broadcast-grade losslessly compressed video over Internet Protocol.

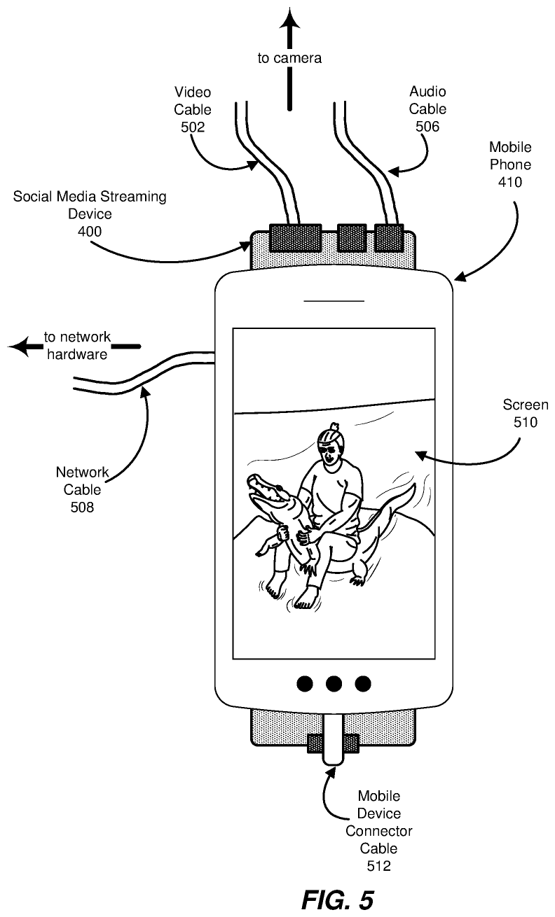

In some embodiments, social media streaming device 400 may connect to mobile phone 410 and/or other devices via physical cables. For example, as illustrated in FIG. 5, a video cable 502 may be connected to video in 402 (and/or video in 404), an audio cable 506 may be connected to audio in 406, a network cable 508 may be connected to network port 408, and/or a mobile device connector cable 512 may be connected to mobile device connector 412. In one embodiment, video cable 502 and/or audio cable 506 may be connected to an external camera, network cable 508 may be connected to network hardware (e.g., a switch, router, and/or access point), and/or mobile device connector cable 512 may be connected to mobile phone 410.

In some embodiments, the systems described herein may enable mobile phone 410 to display the video being captured by the external camera. For example, a screen 510 or mobile phone 410 may display video of an alligator-wrestling competition being streamed via social media streaming device 400.

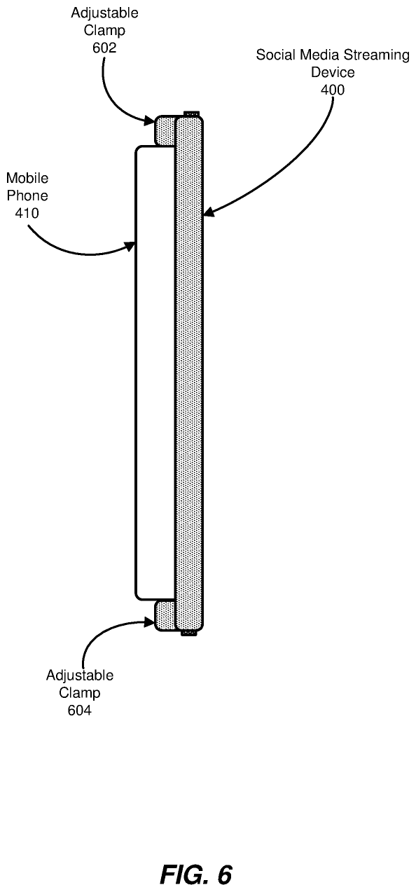

In some embodiments, social media streaming device 400 may be attached to mobile phone 410 via a mobile device attachment mechanism that includes one or more adjustable clamps. For example, as illustrated in FIG. 6, social media streaming device 400 may be attached to mobile phone 410 via an adjustable clamp 602 at the top of mobile phone 410 and/or an adjustable clamp 604 at the bottom of mobile phone 410. Additionally or alternatively, social media streaming device 400 may be attached to mobile phone 410 via clamps that contact the sides of mobile phone 410. By using adjustable clamps, social media streaming device 400 may be capable of securely attaching to mobile devices of different sizes and/or form factors without the use of adhesive or special device cases.

In some embodiments, social media streaming device 400 may be configured to be physically attached to the external camera via a camera attachment mechanism. For example, social media streaming device 400 may be configured with additional clamps (not shown) that attach to the top, side, stand, and/or handle of the external camera.

In some embodiments, a social media streaming device may be configured with one or more applications and/or modules that facilitate posting streaming video to a user's social media page. For example, a social media streaming device may be configured with a social media application. In one embodiment, a social media streaming device may be configured with a credential storage module that stores the user's credentials for the account on the social media platform and enables the social media streaming device to, via an external device with network streaming capabilities, authenticate to the account on the social media platform on behalf of the user. In this embodiment, the social media streaming device may piggyback off another device's network connection (e.g., a mobile phone) to post the streaming video without exposing the user's credentials to the other device, enabling a user to hand off the social media streaming device to a camera operator or assistant while maintaining physical custody of their own phone.

As described above, the systems and methods described herein may facilitate the streaming of live events by the subjects of those events by enabling a user to hand their phone and an attached social media streaming device to a camera operator, who may connect the social media streaming device to the camera and stream live video captured by the camera to the user's social media page with little or no set-up. In some examples, wired connections and/or extra batteries may increase the video streaming capabilities of the connected mobile phone by enabling the mobile phone to more efficiently process and/or transmit high-quality video (e.g. high-definition and/or high-resolution video).

### EXAMPLE EMBODIMENTS

Example 1: A social media streaming device may include (i) a camera connector that connects to and receives streaming video data from an external camera, (ii) a device connector that connects to and sends the streaming video data to a mobile device with network streaming capabilities, and (iii) a video processing module that enables the social media streaming device to, via the mobile device with network streaming capabilities, post the streaming video data to an account on a social media platform on behalf of a user.

Example 2: The social media streaming device of example 1, wherein the mobile device with network streaming capabilities is a smartphone and the device connector is of a connector type designed to create a wired connection to the smartphone.

Example 3: The social media streaming device of examples 1-2 may further include a wired network port that enables the social media streaming device to connect to the network via a wired network connection.

Example 4: The social media streaming device of examples 1-3, where the wired network port enables the mobile device to post the streaming video data to the account on the social media platform via the wired network connection.

Example 5: The social media streaming device of examples 1-4 may further include a battery capable of storing charge sufficient to power the social media streaming device and the mobile device and a power connector that enables the battery to charge the mobile device.

Example 6: The social media streaming device of examples 1-5, where the device connector includes the power connector.

Example 7: The social media streaming device of examples 1-6 may further include a second battery, such that the second battery can be replaced while the battery charges the mobile device and the battery can be replaced while the second battery charges the mobile device.

Example 8: The social media streaming device of examples 1-7 may further include a mobile device attachment mechanism that physically secures the mobile device to the social media streaming device.

Example 9: The social media streaming device of examples 1-8 may further include a camera attachment mechanism that physically secures the social media streaming device to the external camera.

Example 10: The social media streaming device of examples 1-9 may further include a credential storage module that stores the user's credentials for the account on the social media platform and enables the social media streaming device to, via the external device with network streaming capabilities, authenticate to the account on the social media platform on behalf of the user.

Example 11: The social media streaming device of examples 1-10, where the credential storage module on the social media streaming device enables the mobile device to post the streaming video data to the account on the social media platform on behalf of the user without exposing the user's credentials to the mobile device.

Example 12: The social media streaming device of examples 1-11, where the device connector is a locking connector.

Example 13: The social media streaming device of examples 1-12, where the camera connector is a high-definition multimedia interface connector.

Example 14: The social media streaming device of examples 1-13, where the camera connector comprises a high definition serial digital interface connector.

Example 15: A method for social media streaming may include (i) detecting a first physical connection to an external camera that is capturing a video stream, (ii) detecting a second physical connection to a mobile device with network streaming capabilities, and (iii) in response to detecting both the first physical connection and the second physical connection, posting the video stream captured by the external camera to a user account on a social media platform via the mobile device with the network streaming capabilities.

Example 16: The system of example 15, where detecting the first physical connection to the external camera that is capturing the video stream includes detecting a physical connection to a device, identifying the device as the external camera, and receiving the video stream from the external camera.

Example 17: The system of examples 15-16, where detecting the second physical connection to the mobile device with the network streaming capabilities includes detecting a physical connection to a device and identifying the device as a type of device with the network streaming capabilities.

Example 18: The system of examples 15-17, where posting the video stream captured by the external camera to the user account on the social media platform includes receiving the video stream from the external camera, processing the video stream, and transmitting the processed video stream to the mobile device.

Example 19: A system for streaming social media may include at least one physical processor and physical memory including computer-executable instructions that, when executed by the physical processor, cause the physical processor to (i) detect a first physical connection to an external camera that is capturing a video stream, (ii) detect a second physical connection to a mobile device with network streaming capabilities, and (iii) in response to detecting both the first physical connection and the second physical connection, post the video stream captured by the external camera to a user account on a social media platform via the mobile device with the network streaming capabilities.

Example 20: The system of example 19, where

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A social media streaming device comprising:
a camera connector that connects to and receives streaming video data from an external camera;
a device connector that connects to and sends the streaming video data to a mobile device with network streaming capabilities; and
a video processing module that enables the social media streaming device to, via the mobile device with network streaming capabilities, post the streaming video data to an account on a social media platform on behalf of a user.

2. The social media streaming device of claim 1, wherein:
the mobile device with network streaming capabilities comprises a smartphone; and
the device connector is of a connector type designed to create a wired connection to the smartphone.

3. The social media streaming device of claim 1, further comprising a wired network port that enables the social media streaming device to connect to the network via a wired network connection.

4. The social media streaming device of claim 3, wherein the wired network port enables the mobile device to post the streaming video data to the account on the social media platform via the wired network connection.

5. The social media streaming device of claim 1, further comprising:
a battery capable of storing charge sufficient to power the social media streaming device and the mobile device; and
a power connector that enables the battery to charge the mobile device.

6. The social media streaming device of claim 5, wherein the device connector comprises the power connector.

7. The social media streaming device of claim 5, further comprising a second battery, such that the second battery can be replaced while the battery charges the mobile device and the battery can be replaced while the second battery charges the mobile device.

8. The social media streaming device of claim 1, further comprising a mobile device attachment mechanism that physically secures the mobile device to the social media streaming device.

9. The social media streaming device of claim 1, further comprising a camera attachment mechanism that physically secures the social media streaming device to the external camera.

10. The social media streaming device of claim 1, further comprising a credential storage module that stores the user's credentials for the account on the social media platform and enables the social media streaming device to, via the external device with network streaming capabilities, authenticate to the account on the social media platform on behalf of the user.

11. The social media streaming device of claim 10, wherein the credential storage module on the social media streaming device enables the mobile device to post the streaming video data to the account on the social media platform on behalf of the user without exposing the user's credentials to the mobile device.

12. The social media streaming device of claim 1, wherein the device connector comprises a locking connector.

13. The social media streaming device of claim 1, wherein the camera connector comprises a high-definition multimedia interface connector.

14. The social media streaming device of claim 1, wherein the camera connector comprises a high definition serial digital interface connector.

15. A computer-implemented method comprising:
detecting a first physical connection to an external camera that is capturing a video stream;
detecting a second physical connection to a mobile device with network streaming capabilities; and
in response to detecting both the first physical connection and the second physical connection, posting the video stream captured by the external camera to a user account on a social media platform via the mobile device with the network streaming capabilities.

16. The computer-implemented method of claim 15, wherein detecting the first physical connection to the external camera that is capturing the video stream comprises:
detecting a physical connection to a device;
identifying the device as the external camera; and
receiving the video stream from the external camera.

17. The computer-implemented method of claim 15, wherein detecting the second physical connection to the mobile device with the network streaming capabilities comprises:
detecting a physical connection to a device; and
identifying the device as a type of device with the network streaming capabilities.

18. The computer-implemented method of claim 15, wherein posting the video stream captured by the external camera to the user account on the social media platform comprises:
receiving the video stream from the external camera;
processing the video stream; and
transmitting the processed video stream to the mobile device.

19. A system comprising:
at least one physical processor;
physical memory comprising computer-executable instructions that, when executed by the physical processor, cause the physical processor to:
detect a first physical connection to an external camera that is capturing a video stream;
detect a second physical connection to a mobile device with network streaming capabilities; and
in response to detecting both the first physical connection and the second physical connection, post the video stream captured by the external camera to a user account on a social media platform via the mobile device with the network streaming capabilities.

20. The system of claim 19, wherein posting the video stream captured by the external camera to the user account on the social media platform comprises:
receiving the video stream from the external camera;
processing the video stream; and
transmitting the processed video stream to the mobile device.
